(19) United States
(12) Patent Application Publication
(10) Pub. No.: US 2024/0172171 A1
(43) Pub. Date: May 23, 2024

(54) SCHEDULED-IN-ADVANCE MEASUREMENT GAP OR POSITIONING REFERENCE SIGNAL (PRS) PROCESSING WINDOW FOR THE SCHEDULING-IN-ADVANCE POSITIONING FEATURE

(71) Applicant: QUALCOMM Incorporated, San Diego, CA (US)

(72) Inventors: Alexandros MANOLAKOS, Escondido, CA (US); Sony AKKARAKARAN, Poway, CA (US); Mukesh KUMAR, Hyderabad (IN); Guttorm Ringstad OPSHAUG, Redwood City, CA (US); Srinivas YERRAMALLI, San Diego, CA (US); Carlos CABRERA MERCADER, Cardiff, CA (US); Sven FISCHER, Nuremberg (DE)

(21) Appl. No.: 18/551,703

(22) PCT Filed: Mar. 28, 2022
(86) PCT No.: PCT/US2022/071371

§ 371 Date: Sep. 21, 2023

(30) Foreign Application Priority Data
May 13, 2021 (IN) 202141021620

(51) Int. Cl. H04W 64/00; G01S 5/02; H04W 24/10

(52) U.S. Cl. CPC H04W 64/00; G01S 5/0236; G01S 2205/008; H04W 24/10

(57) ABSTRACT

Disclosed are techniques for wireless positioning. In an aspect, a user equipment (UE) receives, from a location server, during a location preparation phase of a positioning session, a location information request, the location information request including a measurement time at which the UE is expected to perform one or more positioning measurements during a first location execution phase of the positioning session, and transmits, to a serving base station, a request for measurement periods, the request for measurement periods including a requested offset for one or more measurement periods to perform the one or more positioning measurements and at least a first start time for the one or more measurement periods, wherein the first start time is greater than the requested offset.

### CROSS-REFERENCE TO RELATED APPLICATIONS

The present Application for Patent claims priority to Indian Patent Application No. 202141021620, entitled “SCHEDULED-IN-ADVANCE MEASUREMENT GAP OR POSITIONING REFERENCE SIGNAL (PRS) PROCESSING WINDOW FOR THE SCHEDULING-IN-ADVANCE POSITIONING FEATURE,” filed May 13, 2021, and is a national stage application, filed under 35 U.S.C. § 371, of International Patent Application No. PCT/US2022/071371, entitled “SCHEDULED-IN-ADVANCE MEASUREMENT GAP OR POSITIONING REFERENCE SIGNAL (PRS) PROCESSING WINDOW FOR THE SCHEDULING-IN-ADVANCE POSITIONING FEATURE,” filed Mar. 28, 2022, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a user equipment (UE) includes receiving, from a location server, during a location preparation phase of a positioning session, a location information request, the location information request including a measurement time at which the UE is expected to perform one or more positioning measurements during a first location execution phase of the positioning session; and transmitting, to a serving base station, a request for measurement periods, the request for measurement periods including a requested offset for one or more measurement periods to perform the one or more positioning measurements and at least a first start time for the one or more measurement periods, wherein the first start time is greater than the requested offset.

In an aspect, a user equipment (UE) includes a memory; at least one transceiver; and at least one processor communicatively coupled to the memory and the at least one transceiver, the at least one processor configured to: receive, via the at least one transceiver, from a location server, during a location preparation phase of a positioning session, a location information request, the location information request including a measurement time at which the UE is expected to perform one or more positioning measurements during a first location execution phase of the positioning session; and transmit, via the at least one transceiver, to a serving base station, a request for measurement periods, the request for measurement periods including a requested offset for one or more measurement periods to perform the one or more positioning measurements and at least a first start time for the one or more measurement periods, wherein the first start time is greater than the requested offset.

In an aspect, a user equipment (UE) includes means for receiving, from a location server, during a location preparation phase of a positioning session, a location information request, the location information request including a measurement time at which the UE is expected to perform one or more positioning measurements during a first location execution phase of the positioning session; and means for transmitting, to a serving base station, a request for measurement periods, the request for measurement periods including a requested offset for one or more measurement periods to perform the one or more positioning measurements and at least a first start time for the one or more measurement periods, wherein the first start time is greater than the requested offset.

In an aspect, a non-transitory computer-readable medium storing computer-executable instructions that, when executed by a user equipment (UE), cause the UE to: receive, from a location server, during a location preparation phase of a positioning session, a location information request, the location information request including a measurement time at which the UE is expected to perform one or more positioning measurements during a first location execution phase of the positioning session; and transmit, to a serving base station, a request for measurement periods, the request for measurement periods including a requested offset for one or more measurement periods to perform the one or more positioning measurements and at least a first start time for the one or more measurement periods, wherein the first start time is greater than the requested offset.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 illustrates an example UE positioning operation, according to aspects of the disclosure.

FIG. 6 illustrates an example Long-Term Evolution (LTE) positioning protocol (LPP) call flow between a UE and a location server for performing positioning operations.

FIGS. 7A and 7B illustrate an example multi-round-trip-time (multi-RTT) positioning procedure using advance scheduling, according to aspects of the disclosure.

FIG. 8 is a diagram 800 of example DL-PRS transmission, processing, and reporting cycles for multiple UEs, according to aspects of the disclosure.

FIGS. 9 to 13 illustrate example “LocationMeasurementInfo” information elements, according to aspects of the disclosure.

FIG. 14 illustrates an example method of wireless positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

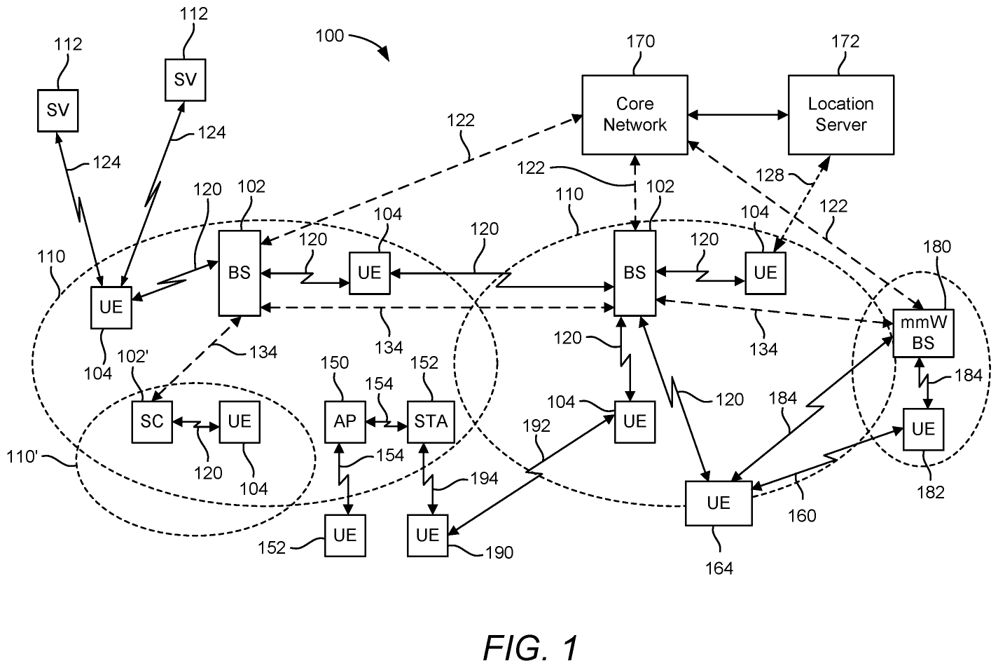

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHZ, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHZ), FR3 (above 52600 MHZ), and FR4 (between FR1 and FR2). mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN

AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

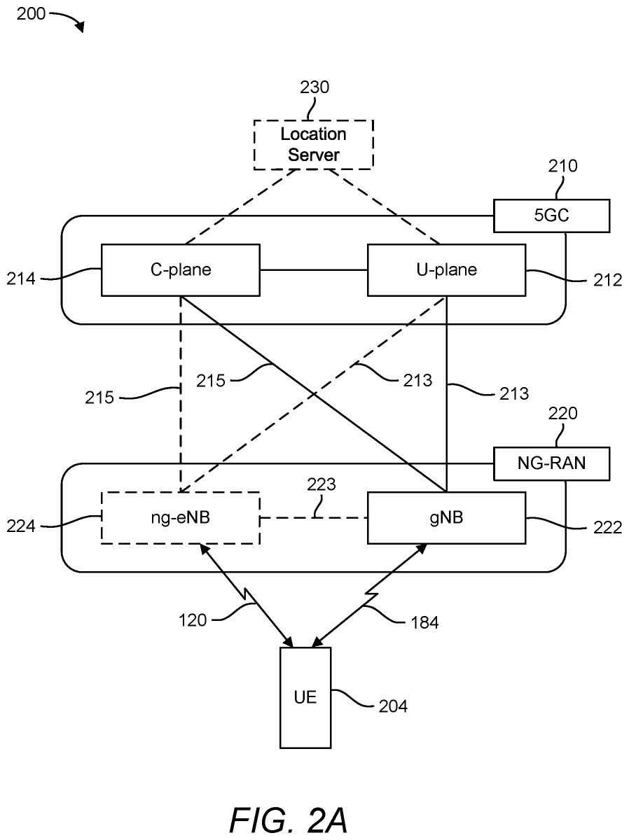

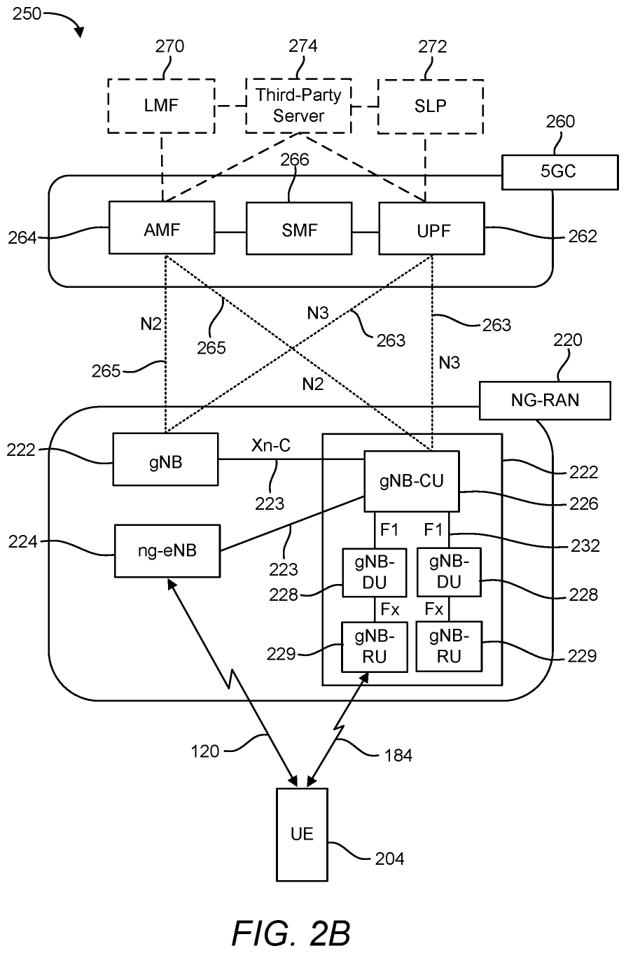

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC, MAC, and PHY layers.

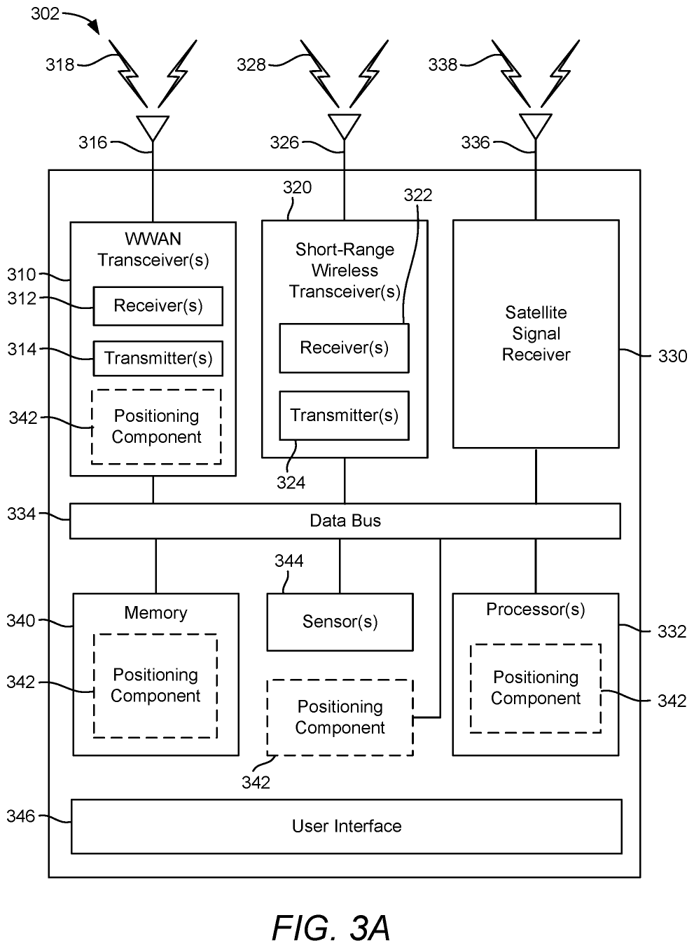

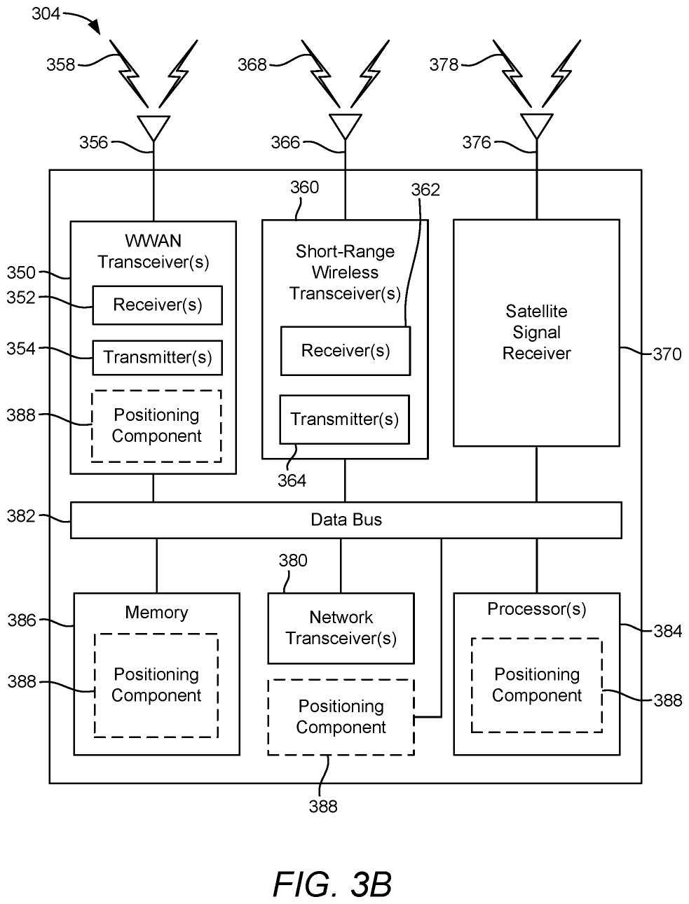

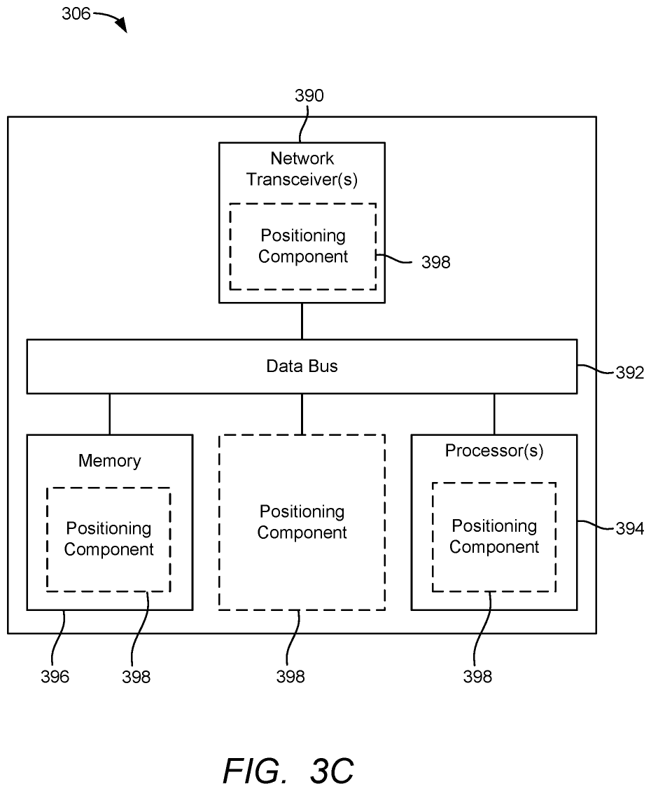

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

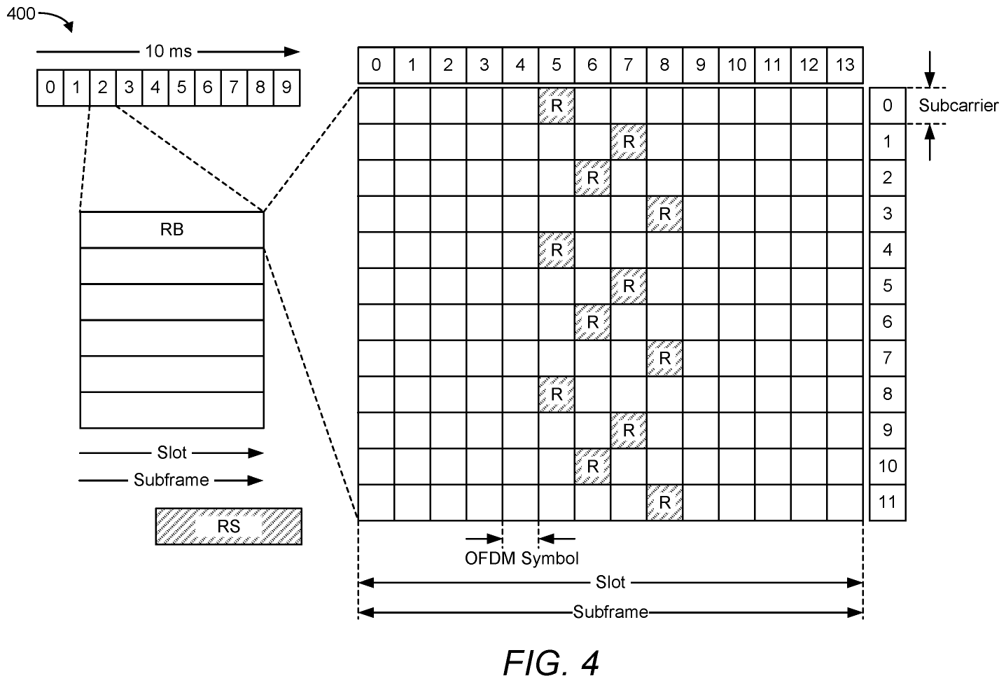

Various frame structures may be used to support downlink and uplink transmissions between network nodes (e.g., base stations and UEs). FIG. 4 is a diagram 400 illustrating an example downlink and/or uplink frame structure, according to aspects of the disclosure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (us), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 us, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 us, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 us, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 us, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying reference signals (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration.

Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-6 (which spans six symbols). That is, the locations of the shaded REs (labeled “R”) indicate a comb-6 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3}; 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the PDSCH are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

With further reference to DL-PRS, DL-PRS have been defined for NR positioning to enable UEs to detect and measure more neighboring TRPs. Several configurations are supported to enable a variety of deployments (e.g., indoor, outdoor, sub-6 GHz, mmW). In addition, both UE-assisted (where a positioning entity other than the UE calculated an estimate of the UE's location) and UE-based (where the UE is the positioning entity that calculates its own location estimate) location calculations are supported in NR. The following table illustrates various types of reference signals that can be used for various positioning methods supported in NR.

TABLE 1

| | | To support the |
|---|---|---|
| DL/UL | | following |
| Reference | | positioning |
| Signals | UE Measurements | techniques |
| DL-PRS | DL-RSTD | DL-TDOA |
| DL-PRS | DL-PRS RSRP | DL-TDOA, DL-AoD, |
| | | Multi-RTT |
| DL-PRS/SRS-for- | UE Rx-Tx | Multi-RTT |
| positioning | | |
| SSB/CSI-RS | Synchronization Signal | E-CID |
| for RRM | (SS)-RSRP (RSRP for | |
| | RRM), SS-RSRQ (for | |
| | RRM), CSI-RSRP (for | |
| | RRM), CSI-RSRQ (for | |
| | RRM) | |

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

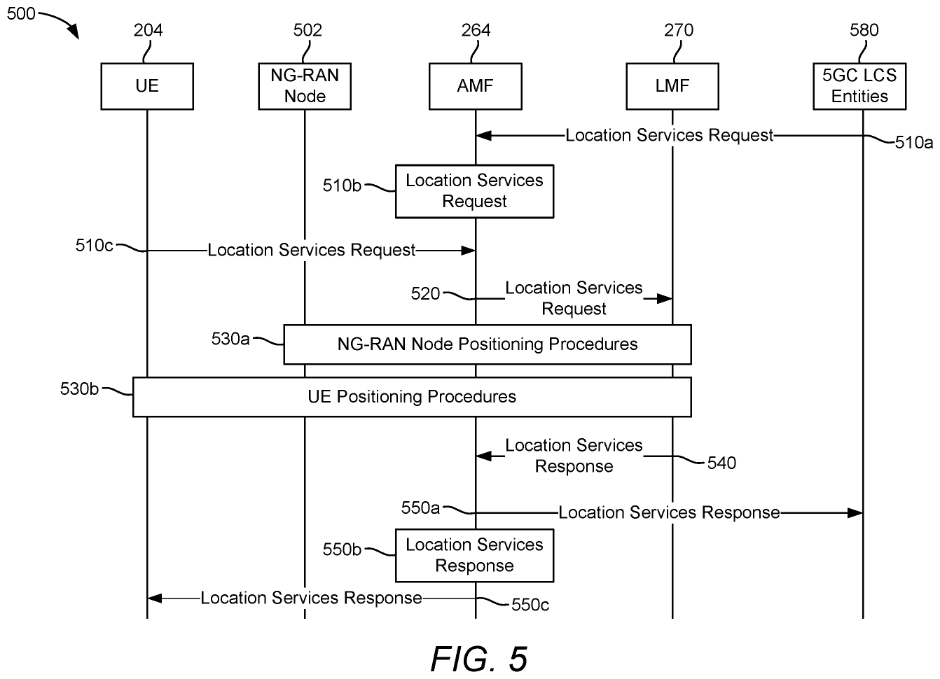

FIG. 5 illustrates an example UE positioning operation 500, according to aspects of the disclosure. The UE positioning operation 500 may be performed by a UE 204, an NG-RAN node 502 (e.g., gNB 222, gNB-CU 226, ng-eNB 224, or other node in the NG-RAN 220) in the NG-RAN 220, an AMF 264, an LMF 270, and a 5GC location services (LCS) entity 580 (e.g., any third-party application requesting the UE's 204 location, public service access point (PSAP), E-911 server, etc.).

A location services request to obtain the location of a target (i.e., UE 204) may be initiated by a 5GC LCS entity 580, the AMF 264 serving the UE 204, or the UE 204 itself. FIG. 5 illustrates these options as stages 510a, 510b, and 510c, respectively. Specifically, at stage 510a, a 5GC LCS entity 580 sends a location services request to the AMF 264. Alternatively, at stage 510b, the AMF 264 generates a location services request itself. Alternatively, at stage 510c, the UE 204 sends a location services request to the AMF 264.

Once the AMF 264 has received (or generated) a location services request, it forwards the location services request to the LMF 270 at stage 520. The LMF 270 then performs NG-RAN positioning procedures with the NG-RAN node 502 at stage 530a and UE positioning procedures with the UE 204 at stage 530b. The specific NG-RAN positioning procedures and UE positioning procedures may depend on the type(s) of positioning method(s) used to locate the UE 204, which may depend on the capabilities of the UE 204. The positioning method(s) may be downlink-based (e.g., LTE-OTDOA, DL-TDOA, and DL-AoD), uplink-based (e.g., UL-TDOA and UL-AoA), and/or downlink-and-uplink-based (e.g., LTE/NR E-CID and RTT), as described above. Corresponding positioning procedures are described in detail in 3GPP Technical Specification (TS) 38.305, which is publicly available and incorporated by reference herein in its entirety.

The NG-RAN positioning procedures and UE positioning procedures may utilize LTE positioning protocol (LPP) signaling between the UE 204 and the LMF 270 and LPP type A (LPPa) or NR positioning protocol type A (NRPPa) signaling between the NG-RAN node 502 and the LMF 270. LPP is used point-to-point between a location server (e.g., LMF 270) and a UE (e.g., UE 204) in order to obtain location-related measurements or a location estimate or to transfer assistance data. A single LPP session is used to support a single location request (e.g., for a single MT-LR, MO-LR, or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures.

A prerequisite for stage 530 is that an LCS Correlation identifier (ID) and the AMF ID has been passed to the LMF 270 by the serving AMF 264. Both, the LCS Correlation ID and the AMF ID may be represented as a string of characters selected by the AMF 264. The LCS Correlation ID and the AMF ID are provided by the AMF 264 to the LMF 270 in the location services request at stage 520. When the LMF 270 then instigates stage 530, the LMF 270 also includes the LCS Correlation ID for this location session, together with the AMF ID, which indicates the AMF instance serving the UE 204. The LCS Correlation identifier is used to ensure that during a positioning session between the LMF 270 and the UE 204, positioning response messages from the UE 204 are returned by the AMF 264 to the correct LMF 270 and carrying an indication (the LCS Correlation identifier) that can be recognized by the LMF 270.

Note that the LCS Correlation ID serves as a location session identifier that may be used to identify messages exchanged between the AMF 264 and the LMF 270 for a particular location session for a UE, as described in greater detail in 3GPP TS 23.273, which is publicly available and incorporated by reference herein in its entirety. As mentioned above and shown in stage 520, a location session between an AMF 264 and an LMF 270 for a particular UE is instigated by the AMF 264, and the LCS Correlation ID may be used to identify this location session (e.g., may be used by the AMF 264 to identify state information for this location session, etc.).

LPP positioning methods and associated signaling content are defined in the 3GPP LPP standard (3GPP TS 37.355, which is publicly available and incorporated by reference herein in its entirety). LPP signaling can be used to request and report measurements related to the following positioning methods: LTE-OTDOA, DL-TDOA, A-GNSS, E-CID, sensor, TBS, WLAN, Bluetooth, DL-AoD, UL-AoA, and multi-RTT. Currently, LPP measurement reports may contain the following measurements: (1) one or more ToA, TDOA, RSTD, or Rx-Tx measurements, (2) one or more AoA and/or AoD measurements (currently only for a base station to report UL-AoA and DL-AoD to the LMF 270), (3) one or more multipath measurements (per-path ToA, RSRP, AoA/AOD), (4) one or more motion states (e.g., walking, driving, etc.) and trajectories (currently only for the UE 204), and (5) one or more report quality indications.

As part of the NG-RAN node positioning procedures (stage 530a) and UE positioning procedures (stage 530b), the LMF 270 may provide LPP assistance data in the form of DL-PRS configuration information to the NG-RAN node 502 and the UE 204 for the selected positioning method(s). Alternatively or additionally, the NG-RAN node 502 may provide DL-PRS and/or UL-PRS configuration information to the UE 204 for the selected positioning method(s). Note that while FIG. 5 illustrates a single NG-RAN node 502, there may be multiple NG-RAN nodes 502 involved in the positioning session.

Once configured with the DL-PRS and UL-PRS configurations, the NG-RAN node 502 and the UE 204 transmit and receive/measure the respective PRS at the scheduled times. The NG-RAN node 502 and the UE 204 then send their respective measurements to the LMF 270.

Once the LMF 270 obtains the measurements from the UE 204 and/or the NG-RAN node 502 (depending on the type(s) of positioning method(s)), it calculates an estimate of the UE's 204 location using those measurements. Then, at stage 540, the LMF 270 sends a location services response, which includes the location estimate for the UE 204, to the AMF 264. The AMF 264 then forwards the location services response to the entity that generated the location services request at stage 510. Specifically, if the location services request was received from a 5GC LCS entity 580 at stage 510a, then at stage 550a, the AMF 264 sends a location services response to the 5GC LCS entity 580. If, however, the location services request was received from the UE 204 at stage 510c, then at stage 550c, the AMF 264 sends a location services response to the UE 204. Or, if the AMF 264 generated the location services request at stage 510b, then at stage 550b, the AMF 264 stores/uses the location services response itself.

Note that although the foregoing has described the UE positioning operation 500 as a UE-assisted positioning operation, it may instead be a UE-based positioning operation. A UE-assisted positioning operation is one where the LMF 270 estimates the location of the UE 204, whereas a UE-based positioning operation is one where the UE 204 estimates its own location.

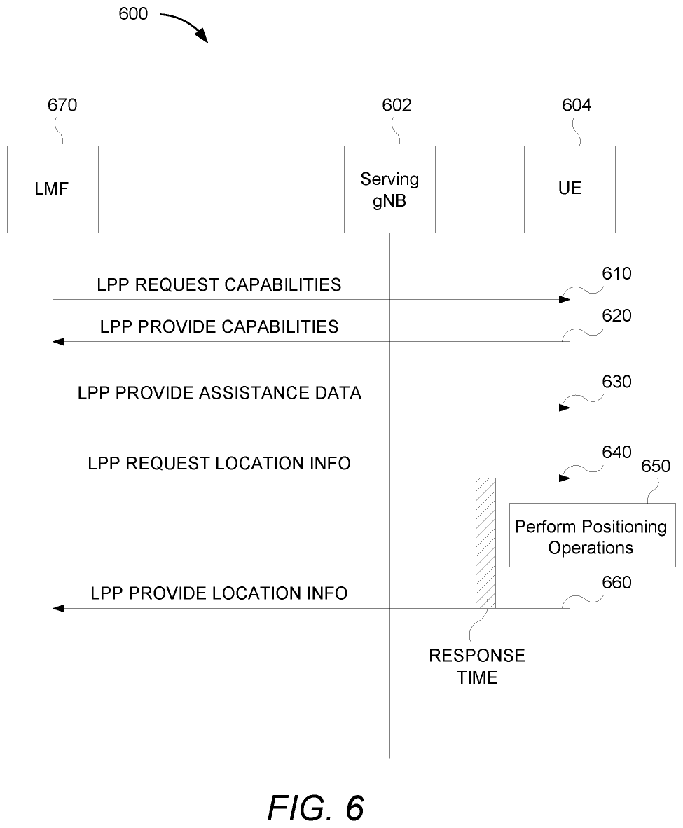

FIG. 6 illustrates an example Long-Term Evolution (LTE) positioning protocol (LPP) procedure 600 between a UE 604 and a location server (illustrated as a location management function (LMF) 670) for performing positioning operations. As illustrated in FIG. 6, positioning of the UE 604 is supported via an exchange of LPP messages between the UE 604 and the LMF 670. The LPP messages may be exchanged between UE 604 and the LMF 670 via the UE's 604 serving base station (illustrated as a serving gNB 602) and a core network (not shown). The LPP procedure 600 may be used to position the UE 604 in order to support various location-related services, such as navigation for UE 604 (or for the user of UE 604), or for routing, or for provision of an accurate location to a public safety answering point (PSAP) in association with an emergency call from UE 604 to a PSAP, or for some other reason. The LPP procedure 600 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 604 may receive a request for its positioning capabilities from the LMF 670 at stage 610 (e.g., an LPP Request Capabilities message). At stage 620, the UE 604 provides its positioning capabilities to the LMF 670 relative to the LPP protocol by sending an LPP Provide Capabilities message to LMF 670 indicating the position methods and features of these position methods that are supported by the UE 604 using LPP. The capabilities indicated in the LPP Provide Capabilities message may, in some aspects, indicate the type of positioning the UE 604 supports (e.g., DL-TDOA, RTT, E-CID, etc.) and may indicate the capabilities of the UE 604 to support those types of positioning.

Upon reception of the LPP Provide Capabilities message, at stage 620, the LMF 670 determines to use a particular type of positioning method (e.g., DL-TDOA, RTT, E-CID, etc.) based on the indicated type(s) of positioning the UE 604 supports and determines a set of one or more transmission-reception points (TRPs) from which the UE 604 is to measure downlink positioning reference signals or towards which the UE 604 is to transmit uplink positioning reference signals. At stage 630, the LMF 670 sends an LPP Provide Assistance Data message to the UE 604 identifying the set of TRPs.

In some implementations, the LPP Provide Assistance Data message at stage 630 may be sent by the LMF 670 to the UE 604 in response to an LPP Request Assistance Data message sent by the UE 604 to the LMF 670 (not shown in FIG. 6). An LPP Request Assistance Data message may include an identifier of the UE's 604 serving TRP and a request for the positioning reference signal (PRS) configuration of neighboring TRPs.

At stage 640, the LMF 670 sends a request for location information to the UE 604. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 630 may be sent after the LPP Request Location Information message at 640 if, for example, the UE 604 sends a request for assistance data to LMF 670 (e.g., in an LPP Request Assistance Data message, not shown in FIG. 6) after receiving the request for location information at stage 640.

At stage 650, the UE 604 utilizes the assistance information received at stage 630 and any additional data (e.g., a desired location accuracy or a maximum response time) received at stage 640 to perform positioning operations (e.g., measurements of DL-PRS, transmission of UL-PRS, etc.) for the selected positioning method.

At stage 660, the UE 604 may send an LPP Provide Location Information message to the LMF 670 conveying the results of any measurements that were obtained at stage 650 (e.g., time of arrival (ToA), reference signal time difference (RSTD), reception-to-transmission (Rx-Tx), etc.) and before or when any maximum response time has expired (e.g., a maximum response time provided by the LMF 670 at stage 640). The LPP Provide Location Information message at stage 660 may also include the time (or times) at which the positioning measurements were obtained and the identity of the TRP(s) from which the positioning measurements were obtained. Note that the time between the request for location information at 640 and the response at 660 is the “response time” and indicates the latency of the positioning session.

The LMF 670 computes an estimated location of the UE 604 using the appropriate positioning techniques (e.g., DL-TDOA, RTT, E-CID, etc.) based, at least in part, on measurements received in the LPP Provide Location Information message at stage 660.

In some scenarios, a target UE (e.g., UE 204), an LCS client (e.g., 5GC LCS entity 580), or an application function (AF) that is requesting the location of the target UE may know the time at which the location should be obtained. For example, in the case of periodic positioning, with a periodic deferred 5GC mobile terminated location request (5GC-MT-LR), the location of a UE is obtained at fixed periodic intervals. In this case, the location time is known in advance. As another example, for industrial IoT (IIoT) positioning, in a factory or warehouse with moving tools, components, packages, etc., there could be a precise expectation of when a moving tool, component, package, etc. will reach a specific location or will have completed a specific movement or operation. It may then be useful or even critical to locate the tool, component, package, etc. to confirm the expectation and make any further adjustments if needed. As yet another example, for scheduled locations, the location of a UE may sometimes be scheduled to occur at specific times in the future. For example, vehicles on a road may all be positioned at the same time to provide an indication of traffic congestion as well as to assist with V2X communications. In addition, people, containers, transportation systems, etc. may also be located at certain common times.

In the scenarios above, the known time, referred to as the scheduled location time, can be provided in advance to reduce the effective latency in providing location results. A general UE positioning operation was described above with reference to FIG. 5. Referring to FIG. 5, the primary impact of advance scheduling to the 5GC is at stages 510 and 520. At stage 510, a scheduled location time Tis included in the location services request from the 5GC LCS entities 580, from the AMF 264, or from the UE 204. The location services request including the scheduled location time T is then transferred to an LMF 270 at stage 520. The scheduled location time T specifies a time in the future at which the location of the UE 204 is to be obtained. Said another way, the scheduled location time Tis the time at which the estimated location of the UE 204 is expected to be valid. The impact to the RAN is at stage 530, where, as part of positioning the UE 204, the LMF 270 schedules positioning measurements to be performed by the UE 204 and/or the NG-RAN node 502 to occur at or near the scheduled location time T. The time at which the UE 204 and/or the NG-RAN node 502 are expected to perform positioning measurements is referred to as the scheduled measurement time T′.

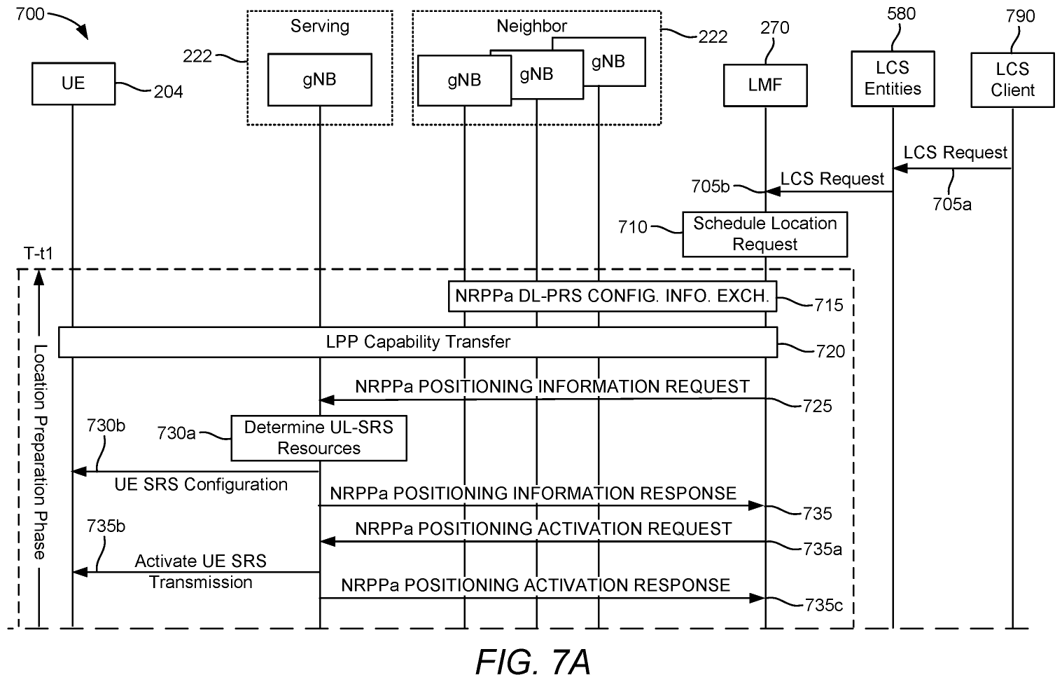

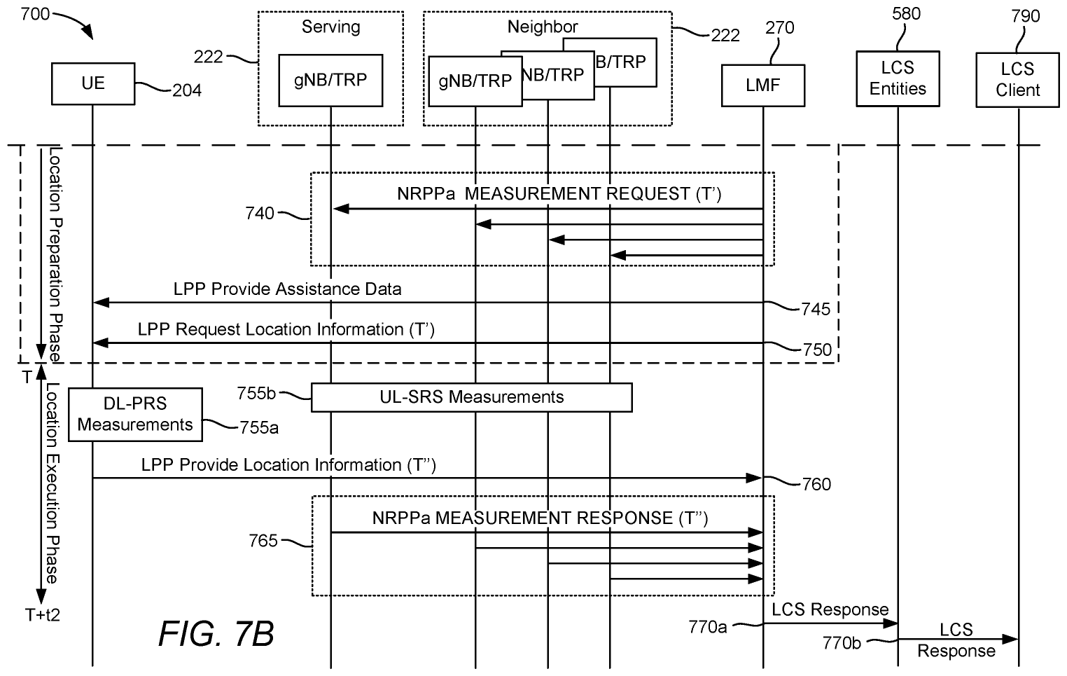

FIGS. 7A and 7B illustrate an example multi-RTT positioning procedure 700 using advance scheduling, according to aspects of the disclosure. As a multi-RTT positioning procedure is a downlink-and-uplink-based positioning procedure, a downlink-based or uplink-based positioning procedure would be a subset of the multi-RTT positioning procedure 700. When a scheduled location time is used, a positioning procedure can be divided into a location preparation phase (stages 705 to 750) and a location execution phase (stages 755 to 765).

The location preparation phase starts at a time T-11 when the LMF 270 receives a location request from an AMF 264 (not shown) and determines the positioning method to be used. The location preparation phase ends after the LMF 270 has requested downlink measurements from the target UE 204, uplink measurements from the involved gNBs 222, and/or a location estimate from the UE 204. The location preparation phase includes any provision of assistance data to the UE (for downlink measurements or a location estimate) and request of configuration information from or provision of configuration information to gNBs 222.

The location execution phase begins at the scheduled location time T when the target UE 204 obtains downlink measurements (and possibly determines a location estimate from these) and/or when the gNBs 222 obtain uplink measurements and ends at a time T+t2 when the UE location information has been provided to the LMF 270 (UE 204 and/or gNB 222 location measurements or UE location estimate). The effective positioning procedure latency in FIGS. 7A and 7B is then determined by the stages comprising the location execution phase only (i.e., between time T and time T+t2).

With specific reference to FIGS. 7A and 7B, at stage 705a, an LCS client 790 (e.g., an application running on the target UE 204, a remote application, etc.) sends an LCS request to the LCS entities 580. The LCS request includes a future time T at which the location of the UE 204 is desired. At stage 705b, the LCS entities 580 forwards the LCS request to the LMF 270. At stage 710, the LMF 270 schedules a location session such that the UE's 204 location can be obtained and be valid at the requested location time T. As shown in FIG. 7A, the subsequent location preparation phase starts at time T−t1, where t1 depends on the expected duration of the location preparation phase. The expected duration of the location preparation phase depends on the selected positioning method, here, a multi-RTT positioning procedure.

At stage 715 (the first stage of the location preparation phase), the LMF 270 performs a DL-PRS configuration information exchange with the serving and neighbor gNBs 222 of the target UE 204 via NRPPa signaling. At stage 720, the LMF 270 performs a capability transfer with the UE 204 via LPP signaling. Specifically, the LMF 270 sends an LPP Request Capabilities message to a target UE 204, as at stage 610 of FIG. 6, and in response, the UE 204 sends an LPP Provide Capabilities message to the LMF 270, as at stage 620 of FIG. 6.

At stage 725, the LMF 270 sends an NRPPa Positioning Information Request to the target UE's 204 serving gNB 222 (or TRP) to request UL-SRS configuration information for the UE 204. The LMF 270 may provide any assistance data needed by the serving gNB 222 (e.g., pathloss reference, spatial relation, SSB configuration, etc.). At stage 730a, the serving gNB 222 determines the resources available for UL-SRS and configures the target UE 204 with the UL-SRS resource sets. At stage 730b, the serving gNB 222 provides the UL-SRS configuration information to the UE 204. At stage 735, the serving gNB 222 sends an NRPPa Positioning Information Response message to the LMF 270. The NRPPa Positioning Information Response message includes the UL-SRS configuration information sent to the UE 204.

At stage 735a, the LMF 270 sends an NRPPa Positioning Activation Request message to the serving gNB 222 instructing it to configure the UE 204 to activate UL-SRS transmission on the configured/allocated resources. The UL-SRS may be aperiodic (e.g., on-demand) UL-SRS, and therefore, at stage 735b, the serving gNB 222 configures/instructs the UE 204 to activate (i.e., begin) UL-SRS transmission. At stage 735c, the serving gNB 222 sends an NRPPa Positioning Activation Response message to the LMF 270 to indicate that UL-SRS transmission has been activated.

At stage 740, the LMF 270 sends an NRPPa Measurement Request message to the gNBs 222. The NRPPa Measurement Request message includes all information needed to enable the gNBs 222 to perform uplink measurements of the UL-SRS transmissions from the target UE 204. The NRPPa Measurement Request message also includes a physical measurement time T′ that indicates when the location measurements are to be obtained. The time T″ defines the time T that the location of the target UE 204 will be valid and may be specified as a system frame number (SFN), a subframe, a slot, an absolute time, etc. The time T′ is provided in the same units as the time T.

At stage 745, the LMF 270 sends assistance data to the UE 204 for the multi-RTT positioning procedure 700 in one or more LPP Provide Assistance Data messages, as at stage 630 of FIG. 6. The LPP Provide Assistance Data message(s) includes all information needed to enable the UE 204 to perform positioning measurements (here, Rx-Tx time difference measurements) of the DL-PRS transmissions from the gNBs 222. At stage 750, the LMF 270 sends an LPP Request Location Information message to the target UE 204, as at stage 640 of FIG. 6. The LPP Request Location Information message may also include the time T′ (although it may be a different time T′ than is provided to the gNBs 222 at stage 740). At this point, the location preparation phase is over.

At stage 755a, the target UE 204 performs measurements (here, Rx-Tx time difference measurements) of the DL-PRS transmitted by the involved gNBs at time T′ (or such that the measurements are valid at time T″) based on the assistance data received at stage 745. At stage 755b, the involved gNBs 222 perform measurements (here, Tx-Rx time difference measurements) of the UL-SRS transmitted by the target UE 204 at time T″ (or such that the measurements are valid at time T′) based on the assistance data received at stage 740 in the NRPPa Measurement Request message.

At stage 760, the target UE 204 sends an LPP Provide Location Information message, as at stage 660 of FIG. 6. The LPP Provide Location Information message includes the positioning measurements performed by the UE 204 at stage 755a. At stage 765, the involved gNBs 222 send NRPPa Measurement Response messages to the LMF 270. The NRPPa Measurement Response messages include the measurements of the UL-SRS measured at stage 755b. The responses at stages 760 and 765 include the time T″ at which the measurements were obtained. The time T″ should be equal to the time T″, but due to processing delays, timing issues, and/or other factors, may not be exactly equal to time T′. The difference between times T″ and T″ is the location time error (8).

At stage 770a, the LMF 270 sends an LCS response message to the LCS entities 580. The LCS response message includes the location of the target UE 204 at time T+8. The LCS entities 580 forward the LCS response message to the LCS client 790. The LCS client 790 receives the location of the target UE 204 with timestamp T+8 at time T+t2, where time t2 is the latency between time T and the response time. The latency 12 as observed by the LCS client 790 excludes the location preparation phase from time T−t1 to time T. Any movement by the UE 204 during the latency time t2 should have a negligible impact on the validity and accuracy of the location estimate. That is, the location of the UE 204 at time T+t2 should be about the same as the location of the UE 204 at time T.

Currently, DL-PRS have lower priority than other channels in LTE and NR. This is because a UE is not expected to process DL-PRS in the same symbol where other downlink signals and channels are transmitted to the UE when there is no measurement gap configured to the UE. That is, a UE's serving base station configures the UE with measurement gaps to enable the UE to measure and process the DL-PRS from other base stations on other frequencies (and as such, a measurement gap may also be referred to as an “inter-frequency measurement gap”). A measurement gap is therefore a time period during which the serving base station does not transmit downlink data to the UE and does not schedule the UE to transmit uplink data to the base station. A UE may request a measurement gap configuration (specifying, e.g., the length and periodicity of the measurement gaps) from the serving base station after receiving the PRS configuration for a positioning session in the assistance data from the location server (e.g., after stage 745 in FIG. 7B). The measurement gap configuration generally coincides with the PRS configuration, and may include some processing time after each PRS occasion.

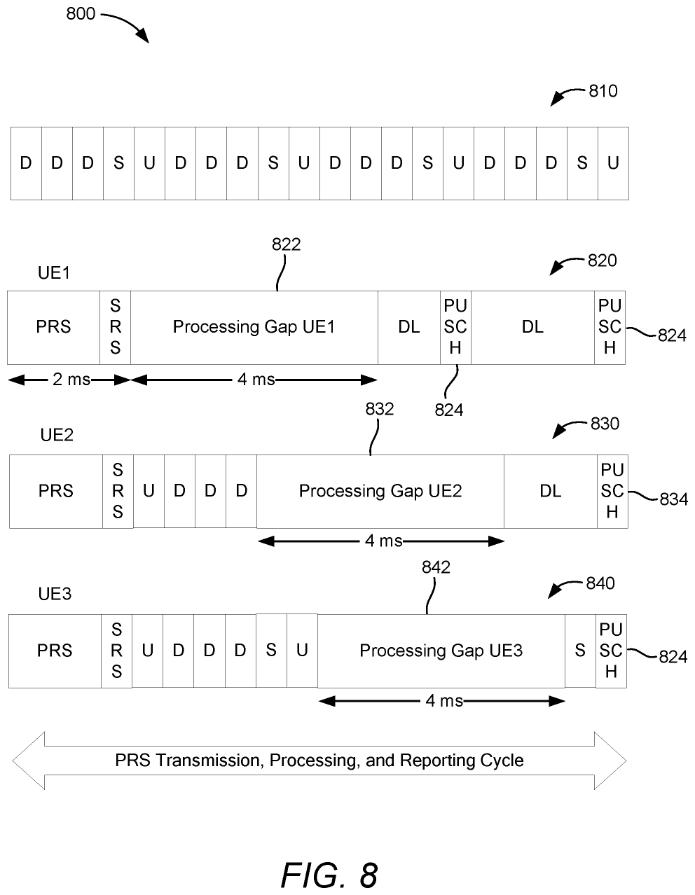

In some cases, to reduce latency, a UE may be permitted to prioritize PRS processing over other downlink channels during a PRS processing window, or gap, which may include prioritization over data, control, and/or any other reference signals. Said another way, a PRS processing gap is a period of time during which the UE is permitted to drop all other processing, channels, and procedures except PRS. The time period of a PRS processing gap may include a time after the PRS is transmitted, meaning that includes time for the UE to finish the processing and not just to “measure” the PRS. There may also be a gap between the time of the measuring and the processing, as illustrated in FIG. 8.

A PRS processing gap is different from an inter-frequency measurement gap. In a PRS processing gap, there are no retuning gaps as in a measurement gap—the UE does not change its BWP and instead continues with the BWP it had before the PRS processing gap (and as such, a PRS processing gap may be referred to as an intra-frequency PRS processing gap). In addition, the location server (e.g., LMF 270), instead of the serving base station, may determine a PRS processing gap, and the UE would not need a processing gap to send an RRC Request to the serving base station and wait for a reply. PRS processing gaps can thereby reduce signaling overhead and latency.

FIG. 8 is a diagram 800 of example DL-PRS transmission, processing, and reporting cycles for multiple UEs, according to aspects of the disclosure. In the example of FIG. 8, three UEs have been configured to use a “DDDSU” frame structure 810 in time-division duplex (TDD) 30 KHz SCS. As noted above, for 30 kHz SCS (μ=1), there are 20 slots per frame and the slot duration is 0.5 ms. Thus, each block of the DDDSU frame structure 810 represents a 0.5 ms slot. The DDDSU frame structure 810 comprises repetitions of three downlink (D) slots, a special (S) slot, and an uplink (U) slot.

In the example of FIG. 8, PRS are received in the first three downlink slots of a frame and an SRS is transmitted in the fourth slot. The PRS and SRS may be received and transmitted, respectively, as part of a downlink-and-uplink-based positioning session, such as an RTT positioning session. The three slots in which the PRS are received (i.e., measured) may correspond to a PRS instance. In general, the PRS instance should be contained within a few milliseconds (here, 2 ms) of the start of the PRS transmission, processing, and reporting cycle. The SRS transmission (if needed, as here, for a downlink-and-uplink-based positioning procedure) should be close to the PRS instance (here, in the next slot).

As shown in FIG. 8, the first UE (labeled “UE1”) has been configured with a PRS transmission, processing, and reporting cycle 820, the second UE (labeled “UE2”) has been configured with a PRS transmission, processing, and reporting cycle 830, and the third UE (labeled “UE3”) has been configured with a PRS transmission, processing, and reporting cycle 840. The PRS transmission, processing, and reporting cycle 820, 830, and 840 may be repeated periodically (e.g., every 10 ms) for some duration of time. Each UE is expected to send a positioning report (e.g., its respective Rx-Tx time difference measurement) at the end of its PRS transmission, processing, and reporting cycle (e.g., every 10 ms). Each UE sends its report on a physical uplink shared channel (PUSCH) (e.g., a configured uplink grant). Specifically, the first UE sends its report on PUSCH 824, the second UE on PUSCH 834, and the third UE on PUSCH 844.

As shown in FIG. 8, the different UEs have each been configured with their own PRS processing gap (or simply “processing gap”), or PRS processing window (or simply “processing window”), in which to process the PRS measured in the first three slots of the frame (e.g., determine the ToA of the PRS and calculate the Rx-Tx time difference measurement). Specifically, the first UE has been configured with a processing gap 822, the second UE with a processing gap 832, and the third UE with a processing gap 842. In the example of FIG. 8, each processing gap is 4 ms in length.

As shown in FIG. 8, each UE's processing gap is offset from the other UEs' processing gaps, but is still within the UE's 10 ms PRS transmission, processing, and reporting cycle. In addition, there is still a PUSCH opportunity for reporting the UE's measurements after the processing gap. Even though there is a gap between the PRS instance and the processing gap for the second and third UEs, because of the short length of the UEs' respective PRS transmission, processing, and reporting cycles 830 and 840, there is limited aging between the measurement and the reporting.

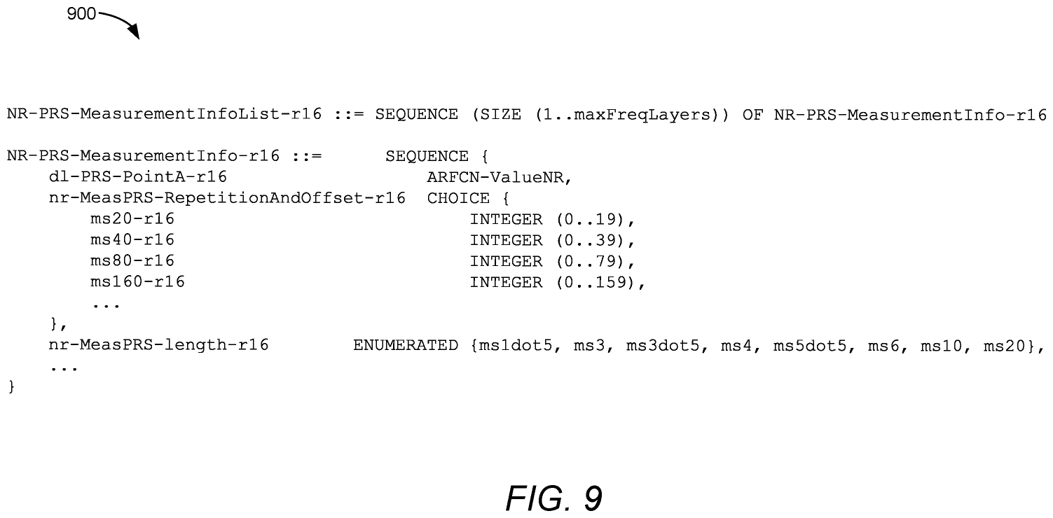

A UE uses the information element (IE) “LocationMeasurementInfo” to request a measurement gap configuration from the serving base station. More specifically, the “LocationMeasurementInfo” IE defines the information sent by the UE to the network to assist with the configuration of measurement gaps for location related measurements. FIG. 9 illustrates an example “LocationMeasurementInfo” IE 900, according to aspects of the disclosure. The following table describes the fields of the “LocationMeasurementInfo” IE 900.

TABLE 2
LocationMeasurementInfo field descriptions

dl-PRS-PointA
The ARFCN value of the carrier received from upper layers for which the
UE needs to perform the NR DL-PRS measurements.
nr-MeasPRS-RepetitionAndOffset
Indicates the gap periodicity in milliseconds and offset in number of
subframes of the requested measurement gap for performing NR DL-PRS
measurements.
nr-MeasPRS-length
Indicates the measurement gap length in milliseconds of the requested
measurement gap for performing NR DL-PRS measurements.

As discussed above with reference to FIGS. 7A and 7B, in a scheduling location in advance scenario, there may be a delay between the receipt of the LPP Request Location Information message at stage 750 and the measurements at stage 755 (performed at measurement time T′). Currently, a UE sends a request for measurement gaps in response to receiving the LPP Request Location Information message. As shown in FIG. 9, a UE can request measurement gaps with a periodicity and an offset of 20, 40, 80, or 160 ms. If the UE requests a measurement gap periodicity and offset of Y ms (i.e., 20, 40, 80, or 160 ms), but the measurements at stage 755 are to be performed at measurement time T′, where the difference between receipt of the LPP Request Location Information message and time T′ is greater than Y ms, the UE will be configured with measurement gaps before it actually needs them. For example, if the requested periodicity and offset is 40 ms and T′ is 100 ms, the UE will be configured with measurement gaps that start 60 ms before it actually needs them.

Accordingly, the present disclosure provides techniques to enable a UE to request measurement gaps to start at a later time that is larger than the requested periodicity and offset. As a first option, the request for measurement gaps may include an SFN and/or a hyper SFN that indicates at which slot or subframe the measurement gaps are requested to start, thereby enabling a UE to request measurement gaps in advance. Hyper SFNs are numbered from 0 to 1023 and therefore repeat every 1024 hyper SFNs. Each hyper SFN includes 1024 SFNs, numbered from 0 to 1023.

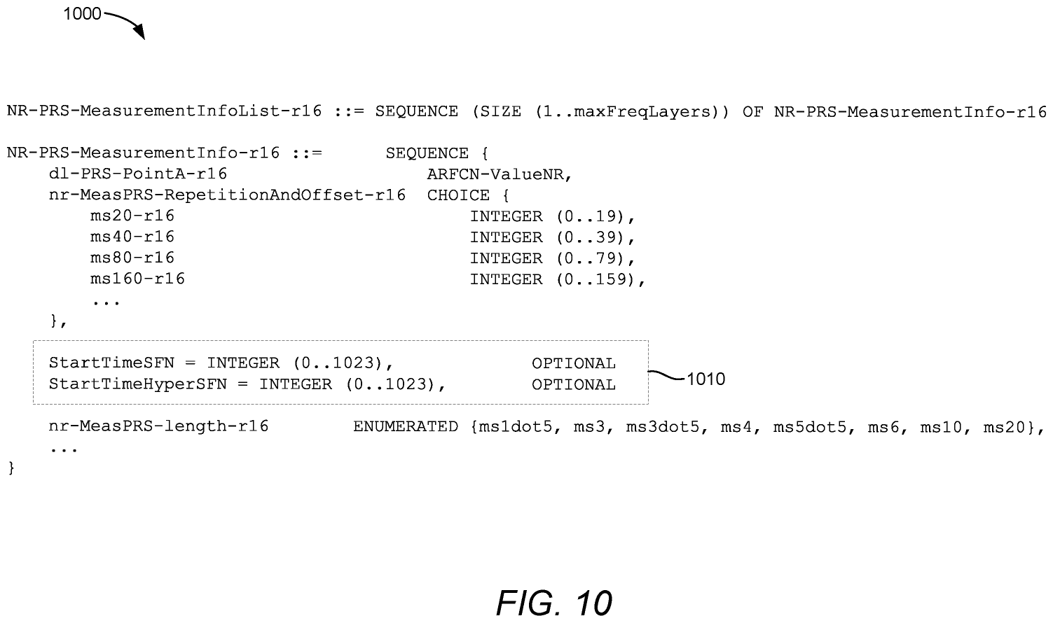

In an aspect, the SFN and/or hyper SFN may be included in the “LocationMeasurementInfo” IE, which may be signaled via RRC or MAC control elements (MAC-CEs). FIG. 10 illustrates an example “LocationMeasurementInfo” IE 1000, according to aspects of the disclosure. The “LocationMeasurementInfo” IE 1000 includes additional fields (compared to the current “LocationMeasurementInfo” IE 900) for a start time SFN (“StartTimeSFN”) and a start time hyper SFN (“StartTimeHyperSFN”). As shown in FIG. 10, the start time SFN may be indicated as an integer from 0 to 1023 and the start time hyper SFN may be indicated as an integer from 0 to 1023. The indicated start time SFN identifies an SFN within the indicated start time hyper SFN. The measurement gap repetition and offset (e.g., the “nr-MeasPRS-RepetitionAndOffset” parameter) is then with respect to the start time SFN and start time hyper SFN.

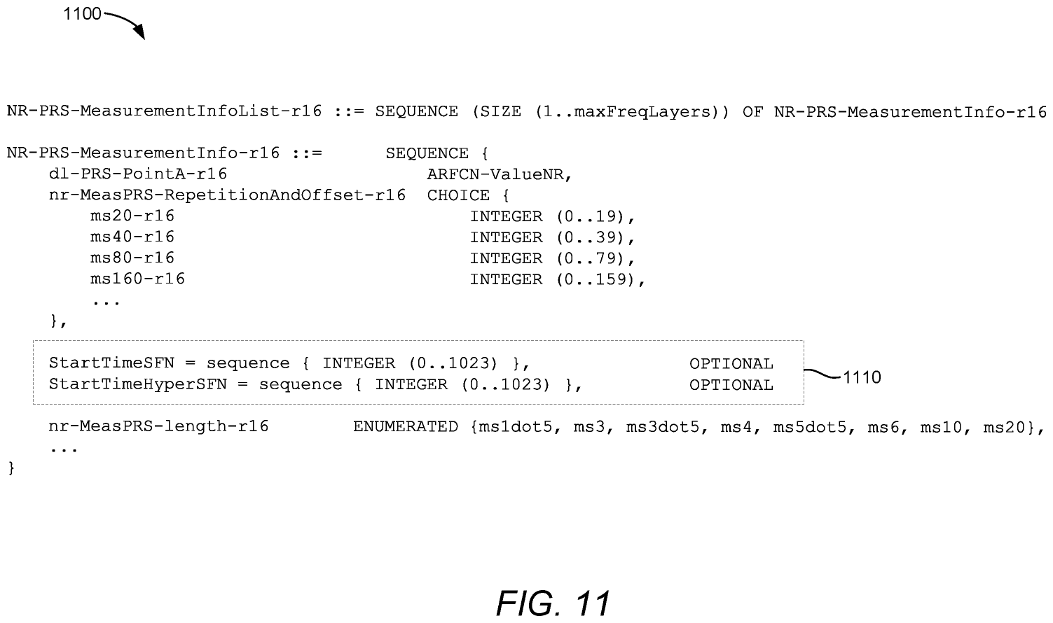

As a second option, the request for measurement gaps may include a sequence of SFNs and/or a hyper SFNs that indicate a sequence of slots or subframes at which the measurement gaps are requested to start. For example, if there is one location preparation phase (e.g., stages 705 to 750) and multiple location execution phases (e.g., stages 755 to 765), then the request for measurement gaps may include a sequence of start times (SFNs and/or hyper SFNs), one start time for each location execution phase. FIG. 11 illustrates an example “LocationMeasurementInfo” IE 1100, according to aspects of the disclosure. The “LocationMeasurementInfo” IE 1100 includes additional fields (compared to the current “LocationMeasurementInfo” IE 900) for a sequence of start time SFNs (“StartTimeSFN”) and a sequence of start time hyper SFNs (“StartTimeHyperSFN”). The measurement gap repetition and offset (e.g., the “nr-MeasPRS-RepetitionAndOffset” parameter) is then with respect to the start time SFN and start time hyper SFN.

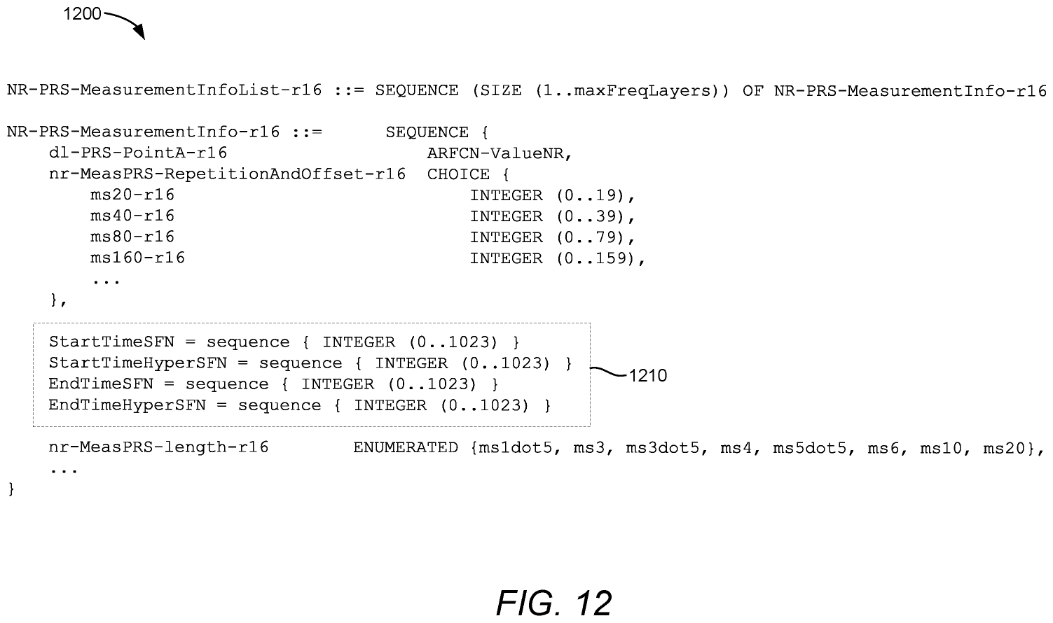

As a third option, the request for measurement gaps may include a sequence of SFNs and/or a hyper SFNs that indicate a sequence of slots or subframes at which the measurement gaps are requested to start. In addition, the request may also include a corresponding sequence of SFNs and/or a hyper SFNs that indicate a sequence of slots or subframes at which the measurement gaps are requested to end. FIG. 12 illustrates an example “LocationMeasurementInfo” IE 1200, according to aspects of the disclosure. Like the “LocationMeasurementInfo” IE 1100, the “LocationMeasurementInfo” IE 1200 includes additional fields (compared to the current “LocationMeasurementInfo” IE 900) for a sequence of start time SFNs (“StartTimeSFN”) and a sequence of start time hyper SFNs (“StartTimeHyperSFN”). In addition, the “LocationMeasurementInfo” IE 1200 includes additional fields for a corresponding sequence of end time SFNs (“EndTimeSFN”) and a corresponding sequence of end time hyper SFNs (“EndTimeHyperSFN”).

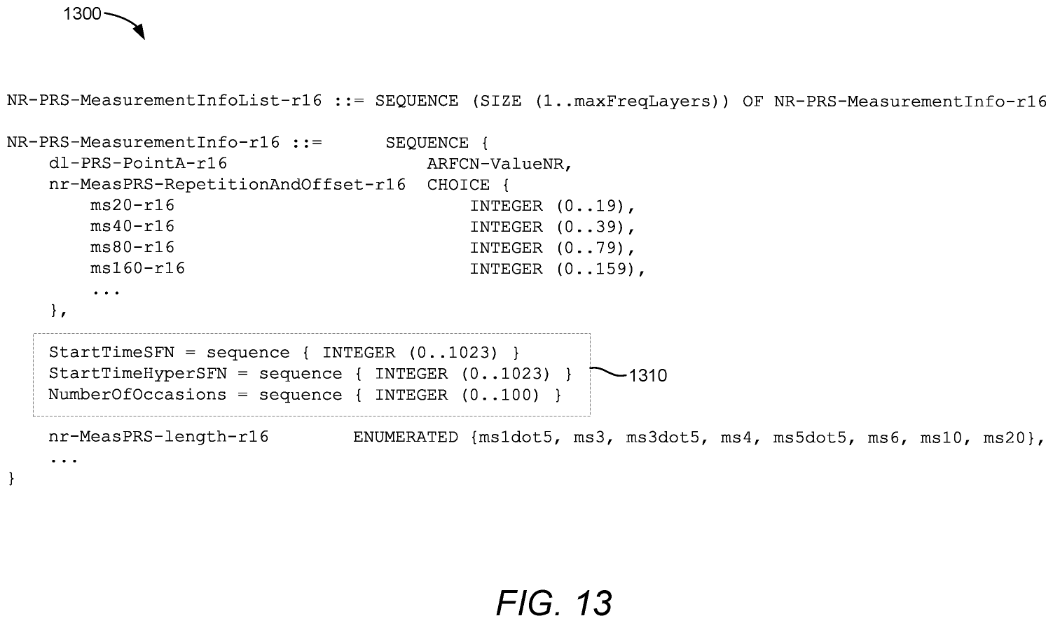

As a fourth option, the request for measurement gaps may include a sequence of SFNs and/or a hyper SFNs that indicate a sequence of slots or subframes at which the measurement gaps are requested to start. In addition, the request may also include a number of occasions that indicate a length, or duration, of the requested measurement gaps. FIG. 13 illustrates an example “LocationMeasurementInfo” IE 1300, according to aspects of the disclosure. Like the “LocationMeasurementInfo” IE 1100, the “LocationMeasurementInfo” IE 1300 includes additional fields (compared to the current “LocationMeasurementInfo” IE 900) for a sequence of start time SFNs (“StartTimeSFN”) and a sequence of start time hyper SFNs (“StartTimeHyperSFN”). In addition, the “LocationMeasurementInfo” IE 1300 includes an additional field for a corresponding sequence of the number of occasions (“NumberOfOccasions”) for which measurement gaps are requested. The value of the number of occasions may be from, for example, 0 to 100.

In an aspect, although the “LocationMeasurementInfo” IE 1000 to 1300 illustrate both a start time SFN and a start time hyper SFN, there may be only a start time SFN, depending on how far into the future the measurement gaps are requested. Similarly, while the “LocationMeasurementInfo” IE 1200 illustrates both an end time SFN and an end time hyper SFN, there may be only a start time SFN, depending on how far into the future the end of the measurement gaps is requested.

Further, while the “LocationMeasurementInfo” IEs 1200 and 1300 include sequences of start times and end times or start times and numbers of occasions, respectively, there may only be a single start time (start time SFN and/or start time hyper SFN) and end time (end time SFN and/or end time hyper SFN or number of occasions). In that case, the “sequence” may be a sequence of only “one.”

In an aspect, the disclosed requests for measurement gaps (e.g., “LocationMeasurementInfo” IEs 1000 to 1300) may only be applicable for the case that the UE is requesting measurement gaps for positioning, as opposed to measurement gaps for mobility measurements (e.g., radio resource management (RRM) measurements).

In an aspect, the disclosed requests for measurement gaps (e.g., “LocationMeasurementInfo” IEs 1000 to 1300) may only be applicable when the UE has received a location request with a T′ value. That is, a UE may only use the disclosed requests inside a location preparation phase of a scheduling in advance procedure.

In an aspect, a UE may include separate start times (and optionally durations) for each frequency layer on which the UE is requesting measurement gaps. These separate start times may be a sequence of start times (as in FIGS. 11 to 13) or a list of start times in the same measurement gap request, or separate measurement gap requests for each frequency layer. Alternatively, the start times may be the same across all frequency layers.

In response to the request for measurement gaps, the serving base station sends the UE a message that includes the requested measurement gap configuration. This message will also include a SFN and/or hyper SFN (or other start time indicator) for the measurement gaps. These may be provided in fields similar to the fields illustrated in FIGS. 10 to 13.

If there are multiple execution phases, there may also be a sequence of start times and durations (or numbers of occasions), as illustrated in FIGS. 11 to 13.

As with the request for measurement gaps, the response may include separate start times (and optionally durations) for each frequency layer on which the UE is requesting measurement gaps. These separate start times may be a sequence of start times (as in FIGS. 11 to 13) or a list of start times in the same measurement gap response, or separate measurement gap responses for each frequency layer. Alternatively, the start times may be the same across all frequency layers.

While the foregoing has generally described various requests for inter-frequency measurement gaps, as will be appreciated, the above techniques are equally applicable to requests for PRS processing gaps (described above with reference to FIG. 8). That is, a UE may request one or more start times (and optionally corresponding durations) for a sequence of one or more PRS processing gaps, where the requested start time(s) are greater than the requested offset(s) for the sequence of one or more PRS processing gaps. Inter-frequency measurement gaps and PRS processing gaps may be referred to collectively herein as simply “measurement periods.”

In an aspect, while the requested start time (e.g., start time SFN and/or start time hyper SFN) may be greater than the requested measurement gap offset, that need not be the case. However, where the start time is less than the requested offset, there is no particular need to include a requested start time in the measurement gap request.

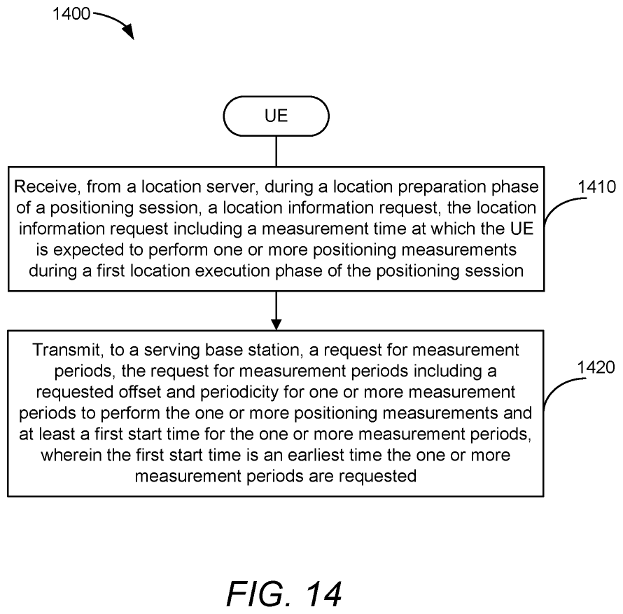

FIG. 14 illustrates an example method 1400 of wireless positioning, according to aspects of the disclosure. In an aspect, method 1400 may be performed by a UE (e.g., any of the UEs described herein).

At 1410, the UE receives, from a location server (e.g., LMF 270), during a location preparation phase of a positioning session (e.g., multi-RTT, DL-TDOA, UL-TDOA, E-CID, etc. positioning session), a location information request, the location information request including a measurement time (e.g., T′) at which the UE is expected to perform one or more positioning measurements during a first location execution phase of the positioning session. In an aspect, operation 1410 may be performed by the one or more WWAN transceivers 310, the one or more processors 332, memory 340, and/or positioning component 342, any or all of which may be considered means for performing this operation.

At 1420, the UE transmits, to a serving base station (e.g., gNB 222), a request for measurement periods, the request for measurement periods including a requested offset for one or more measurement periods to perform the one or more positioning measurements and at least a first start time for the one or more measurement periods, wherein the first start time is greater than the requested offset. In an aspect, operation 1420 may be performed by the one or more WWAN transceivers 310, the one or more processors 332, memory 340, and/or positioning component 342, any or all of which may be considered means for performing this operation.

As will be appreciated, a technical advantage of the method 1400 is lower latency and improved resource utilization since the UE will not be configured with measurement gaps before they are actually needed.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a user equipment (UE), comprising: receiving, from a location server, during a location preparation phase of a positioning session, a location information request, the location information request including a measurement time at which the UE is expected to perform one or more positioning measurements during a first location execution phase of the positioning session; and transmitting, to a serving base station, a request for measurement periods, the request for measurement periods including a requested offset for one or more measurement periods to perform the one or more positioning measurements and at least a first start time for the one or more measurement periods, wherein the first start time is greater than the requested offset.

Clause 2. The method of clause 1, wherein the first start time comprises a system frame number, a hyper system frame number, or both.

Clause 3. The method of clause 1, wherein the first start time comprises an absolute time.

Clause 4. The method of any of clauses 1 to 3, wherein the request for measurement periods further includes at least a first end time for the one or more measurement periods.

Clause 5. The method of clause 4, wherein at least the first end time for the one or more measurement periods comprises a sequence of a plurality of end times for the one or more measurement periods.

Clause 6. The method of clause 5, wherein each of the plurality of end times corresponds to a different location execution phase associated with the location preparation phase.

Clause 7. The method of clause 5, wherein each of the plurality of end times corresponds to a different positioning frequency layer associated with the one or more positioning measurements.

Clause 8. The method of any of clauses 1 to 7, wherein the request for measurement periods further includes an indication of at least a first duration for the one or more measurement periods.

Clause 9. The method of clause 8, wherein the indication of at least the first duration comprises a number of occasions.

Clause 10. The method of clause 8, wherein the indication of at least the first duration comprises an end time.

Clause 11. The method of clause 10, wherein the end time comprises a system frame number, a hyper system frame number, or both.

Clause 12. The method of any of clauses 8 to 11, wherein the indication of at least the first duration for the one or more measurement periods comprises a sequence of a plurality of durations for the one or more measurement periods.

Clause 13. The method of clause 12, wherein each of the plurality of durations corresponds to a different location execution phase associated with the location preparation phase.

Clause 14. The method of clause 12, wherein each of the plurality of durations corresponds to a different positioning frequency layer associated with the one or more positioning measurements.

Clause 15. The method of any of clauses 1 to 14, wherein at least the first start time for the one or more measurement periods comprises a sequence of a plurality of start times for the one or more measurement periods.

Clause 16. The method of clause 15, wherein each of the plurality of start times corresponds to a different location execution phase associated with the location preparation phase.

Clause 17. The method of clause 15, wherein each of the plurality of start times corresponds to a different positioning frequency layer associated with the one or more positioning measurements.

Clause 18. The method of any of clauses 1 to 17, wherein: the request for measurement periods comprises a request for inter-frequency measurement gaps, and the one or more measurement periods comprise one or more inter-frequency measurement gaps.

Clause 19. The method of clause 18, wherein the one or more inter-frequency measurement gaps comprise one or more inter-frequency measurement gaps for positioning.

Clause 20. The method of any of clauses 1 to 17, wherein: the request for measurement periods comprises a request for intra-frequency processing gaps, and the one or more measurement periods comprise one or more intra-frequency processing gaps.

Clause 21. The method of any of clauses 1 to 20, wherein the location information request is a Long-Term Evolution (LTE) positioning protocol (LPP) Request Location Information message.

Clause 22. The method of any of clauses 1 to 21, wherein the request for measurement periods is signaled in one or more radio resource control (RRC) messages or one or more medium access control control elements (MAC-CEs).

Clause 23. The method of any of clauses 1 to 22, wherein: the request for measurement periods comprises a “LocationMeasurementInfo” information element (IE), and the requested offset is a nr-MeasPRS-RepetitionAndOffset parameter.

Clause 24. The method of any of clauses 1 to 23, further comprising: receiving, from the serving base station, a response to the request for measurement periods, the response including at least a second start time for the one or more measurement periods, the second start time based on the first start time.

Clause 25. The method of clause 24, wherein the second start time is the same as the first start time.

Clause 26. An apparatus comprising a memory, at least one transceiver, and at least one processor communicatively coupled to the memory and the at least one transceiver, the at least one processor configured to perform a method in accordance with any of clauses 1 to 25.

Clause 27. An apparatus comprising means for performing a method in accordance with any of clauses 1 to 25.

Clause 28. A computer-readable medium storing computer-executable instructions, the computer-executable instructions comprising at least one instruction for causing an apparatus to perform a method in accordance with any of clauses 1 to 25.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless positioning performed by a user equipment (UE), comprising:
receiving, from a location server, during a location preparation phase of a positioning session, a location information request, the location information request including a measurement time at which the UE is expected to perform one or more positioning measurements during a first location execution phase of the positioning session; and
transmitting, to a serving base station, a request for measurement periods, the request for measurement periods including a requested offset for one or more measurement periods to perform the one or more positioning measurements and at least a first start time for the one or more measurement periods, wherein the first start time is greater than the requested offset.

2. The method of claim 1, wherein the first start time comprises a system frame number, a hyper system frame number, or both.

3. The method of claim 1, wherein the first start time comprises an absolute time.

4. The method of claim 1, wherein the request for measurement periods further includes at least a first end time for the one or more measurement periods.

5. The method of claim 4, wherein at least the first end time for the one or more measurement periods comprises a sequence of a plurality of end times for the one or more measurement periods.

6. The method of claim 5, wherein each of the plurality of end times corresponds to a different location execution phase associated with the location preparation phase.

7. The method of claim 5, wherein each of the plurality of end times corresponds to a different positioning frequency layer associated with the one or more positioning measurements.

8. The method of claim 1, wherein the request for measurement periods further includes an indication of at least a first duration for the one or more measurement periods.

9. The method of claim 8, wherein the indication of at least the first duration comprises a number of occasions.

10. The method of claim 8, wherein the indication of at least the first duration comprises an end time.

11. The method of claim 10, wherein the end time comprises a system frame number, a hyper system frame number, or both.

12. The method of claim 8, wherein the indication of at least the first duration for the one or more measurement periods comprises a sequence of a plurality of durations for the one or more measurement periods.

13. The method of claim 12, wherein each of the plurality of durations corresponds to a different location execution phase associated with the location preparation phase.

14. The method of claim 12, wherein each of the plurality of durations corresponds to a different positioning frequency layer associated with the one or more positioning measurements.

15. The method of claim 1, wherein at least the first start time for the one or more measurement periods comprises a sequence of a plurality of start times for the one or more measurement periods.

16. The method of claim 15, wherein each of the plurality of start times corresponds to a different location execution phase associated with the location preparation phase.

17. The method of claim 15, wherein each of the plurality of start times corresponds to a different positioning frequency layer associated with the one or more positioning measurements.

18. The method of claim 1, wherein:
the request for measurement periods comprises a request for inter-frequency measurement gaps, and
the one or more measurement periods comprise one or more inter-frequency measurement gaps.

19. The method of claim 18, wherein the one or more inter-frequency measurement gaps comprise one or more inter-frequency measurement gaps for positioning.

20. The method of claim 1, wherein:
the request for measurement periods comprises a request for intra-frequency processing gaps, and
the one or more measurement periods comprise one or more intra-frequency processing gaps.

21. The method of claim 1, wherein the location information request is a Long-Term Evolution (LTE) positioning protocol (LPP) Request Location Information message.

22. The method of claim 1, wherein the request for measurement periods is signaled in one or more radio resource control (RRC) messages or one or more medium access control control elements (MAC-CEs).

23. The method of claim 1, wherein:
the request for measurement periods comprises a “LocationMeasurementInfo” information element (IE), and
the requested offset is a nr-MeasPRS-RepetitionAndOffset parameter.

24. The method of claim 1, further comprising:
receiving, from the serving base station, a response to the request for measurement periods, the response including at least a second start time for the one or more measurement periods, the second start time based on the first start time.

25. The method of claim 24, wherein the second start time is the same as the first start time.

26. A user equipment (UE), comprising:
a memory;
at least one transceiver; and
at least one processor communicatively coupled to the memory and the at least one transceiver, the at least one processor configured to:
receive, via the at least one transceiver, from a location server, during a location preparation phase of a positioning session, a location information request, the location information request including a measurement time at which the UE is expected to perform one or more positioning measurements during a first location execution phase of the positioning session; and
transmit, via the at least one transceiver, to a serving base station, a request for measurement periods, the request for measurement periods including a requested offset for one or more measurement periods to perform the one or more positioning measurements and at least a first start time for the one or more measurement periods, wherein the first start time is greater than the requested offset.

27. The UE of claim 26, wherein the first start time comprises a system frame number, a hyper system frame number, or both.

28. The UE of claim 26, wherein the first start time comprises an absolute time.

29. The UE of claim 26, wherein the request for measurement periods further includes at least a first end time for the one or more measurement periods.

30. The UE of claim 29, wherein at least the first end time for the one or more measurement periods comprises a sequence of a plurality of end times for the one or more measurement periods.

31. The UE of claim 30, wherein each of the plurality of end times corresponds to a different location execution phase associated with the location preparation phase.

32. The UE of claim 30, wherein each of the plurality of end times corresponds to a different positioning frequency layer associated with the one or more positioning measurements.

33. The UE of claim 26, wherein the request for measurement periods further includes an indication of at least a first duration for the one or more measurement periods.

34. The UE of claim 33, wherein the indication of at least the first duration comprises a number of occasions.

35. The UE of claim 33, wherein the indication of at least the first duration comprises an end time.

36. The UE of claim 35, wherein the end time comprises a system frame number, a hyper system frame number, or both.

37. The UE of claim 33, wherein the indication of at least the first duration for the one or more measurement periods comprises a sequence of a plurality of durations for the one or more measurement periods.

38. The UE of claim 37, wherein each of the plurality of durations corresponds to a different location execution phase associated with the location preparation phase.

39. The UE of claim 37, wherein each of the plurality of durations corresponds to a different positioning frequency layer associated with the one or more positioning measurements.

40. The UE of claim 26, wherein at least the first start time for the one or more measurement periods comprises a sequence of a plurality of start times for the one or more measurement periods.

41. The UE of claim 40, wherein each of the plurality of start times corresponds to a different location execution phase associated with the location preparation phase.

42. The UE of claim 40, wherein each of the plurality of start times corresponds to a different positioning frequency layer associated with the one or more positioning measurements.

43. The UE of claim 26, wherein:
the request for measurement periods comprises a request for inter-frequency measurement gaps, and
the one or more measurement periods comprise one or more inter-frequency measurement gaps.

44. The UE of claim 43, wherein the one or more inter-frequency measurement gaps comprise one or more inter-frequency measurement gaps for positioning.

45. The UE of claim 26, wherein:
the request for measurement periods comprises a request for intra-frequency processing gaps, and
the one or more measurement periods comprise one or more intra-frequency processing gaps.

46. The UE of claim 26, wherein the location information request is a Long-Term Evolution (LTE) positioning protocol (LPP) Request Location Information message.

47. The UE of claim 26, wherein the request for measurement periods is signaled in one or more radio resource control (RRC) messages or one or more medium access control control elements (MAC-CEs).

48. The UE of claim 26, wherein:
the request for measurement periods comprises a “LocationMeasurementInfo” information element (IE), and
the requested offset is a nr-MeasPRS-RepetitionAndOffset parameter.

49. The UE of claim 26, wherein the at least one processor is further configured to:
receive, via the at least one transceiver, from the serving base station, a response to the request for measurement periods, the response including at least a second start time for the one or more measurement periods, the second start time based on the first start time.

50. The UE of claim 49, wherein the second start time is the same as the first start time.

51. A user equipment (UE), comprising:
means for receiving, from a location server, during a location preparation phase of a positioning session, a location information request, the location information request including a measurement time at which the UE is expected to perform one or more positioning measurements during a first location execution phase of the positioning session; and
means for transmitting, to a serving base station, a request for measurement periods, the request for measurement periods including a requested offset for one or more measurement periods to perform the one or more positioning measurements and at least a first start time for the one or more measurement periods, wherein the first start time is greater than the requested offset.

52. The UE of claim 51, wherein the first start time comprises a system frame number, a hyper system frame number, or both.

53. The UE of claim 51, wherein the first start time comprises an absolute time.

54. The UE of claim 51, wherein the request for measurement periods further includes at least a first end time for the one or more measurement periods.

55. The UE of claim 54, wherein at least the first end time for the one or more measurement periods comprises a sequence of a plurality of end times for the one or more measurement periods.

56. The UE of claim 55, wherein each of the plurality of end times corresponds to a different location execution phase associated with the location preparation phase.

57. The UE of claim 55, wherein each of the plurality of end times corresponds to a different positioning frequency layer associated with the one or more positioning measurements.

58. The UE of claim 51, wherein the request for measurement periods further includes an indication of at least a first duration for the one or more measurement periods.

59. The UE of claim 58, wherein the indication of at least the first duration comprises a number of occasions.

60. The UE of claim 58, wherein the indication of at least the first duration comprises an end time.

61. The UE of claim 60, wherein the end time comprises a system frame number, a hyper system frame number, or both.

62. The UE of claim 58, wherein the indication of at least the first duration for the one or more measurement periods comprises a sequence of a plurality of durations for the one or more measurement periods.

63. The UE of claim 62, wherein each of the plurality of durations corresponds to a different location execution phase associated with the location preparation phase.

64. The UE of claim 62, wherein each of the plurality of durations corresponds to a different positioning frequency layer associated with the one or more positioning measurements.

65. The UE of claim 51, wherein at least the first start time for the one or more measurement periods comprises a sequence of a plurality of start times for the one or more measurement periods.

66. The UE of claim 65, wherein each of the plurality of start times corresponds to a different location execution phase associated with the location preparation phase.

67. The UE of claim 65, wherein each of the plurality of start times corresponds to a different positioning frequency layer associated with the one or more positioning measurements.

68. The UE of claim 51, wherein:
the request for measurement periods comprises a request for inter-frequency measurement gaps, and
the one or more measurement periods comprise one or more inter-frequency measurement gaps.

69. The UE of claim 68, wherein the one or more inter-frequency measurement gaps comprise one or more inter-frequency measurement gaps for positioning.

70. The UE of claim 51, wherein:
the request for measurement periods comprises a request for intra-frequency processing gaps, and
the one or more measurement periods comprise one or more intra-frequency processing gaps.

71. The UE of claim 51, wherein the location information request is a Long-Term Evolution (LTE) positioning protocol (LPP) Request Location Information message.

72. The UE of claim 51, wherein the request for measurement periods is signaled in one or more radio resource control (RRC) messages or one or more medium access control control elements (MAC-CEs).

73. The UE of claim 51, wherein:
the request for measurement periods comprises a “LocationMeasurementInfo” information element (IE), and
the requested offset is a nr-MeasPRS-RepetitionAndOffset parameter.

74. The UE of claim 51, further comprising:
means for receiving, from the serving base station, a response to the request for measurement periods, the response including at least a second start time for the one or more measurement periods, the second start time based on the first start time.

75. The UE of claim 74, wherein the second start time is the same as the first start time.

76. A non-transitory computer-readable medium storing computer-executable instructions that, when executed by a user equipment (UE), cause the UE to:
receive, from a location server, during a location preparation phase of a positioning session, a location information request, the location information request including a measurement time at which the UE is expected to perform one or more positioning measurements during a first location execution phase of the positioning session; and
transmit, to a serving base station, a request for measurement periods, the request for measurement periods including a requested offset for one or more measurement periods to perform the one or more positioning measurements and at least a first start time for the one or more measurement periods, wherein the first start time is greater than the requested offset.

77. The non-transitory computer-readable medium of claim 76, wherein the first start time comprises a system frame number, a hyper system frame number, or both.

78. The non-transitory computer-readable medium of claim 76, wherein the first start time comprises an absolute time.

79. The non-transitory computer-readable medium of claim 76, wherein the request for measurement periods further includes at least a first end time for the one or more measurement periods.

80. The non-transitory computer-readable medium of claim 79, wherein at least the first end time for the one or more measurement periods comprises a sequence of a plurality of end times for the one or more measurement periods.

81. The non-transitory computer-readable medium of claim 80, wherein each of the plurality of end times corresponds to a different location execution phase associated with the location preparation phase.

82. The non-transitory computer-readable medium of claim 80, wherein each of the plurality of end times corresponds to a different positioning frequency layer associated with the one or more positioning measurements.

83. The non-transitory computer-readable medium of claim 76, wherein the request for measurement periods further includes an indication of at least a first duration for the one or more measurement periods.

84. The non-transitory computer-readable medium of claim 83, wherein the indication of at least the first duration comprises a number of occasions.

85. The non-transitory computer-readable medium of claim 83, wherein the indication of at least the first duration comprises an end time.

86. The non-transitory computer-readable medium of claim 85, wherein the end time comprises a system frame number, a hyper system frame number, or both.

87. The non-transitory computer-readable medium of claim 83, wherein the indication of at least the first duration for the one or more measurement periods comprises a sequence of a plurality of durations for the one or more measurement periods.

88. The non-transitory computer-readable medium of claim 87, wherein each of the plurality of durations corresponds to a different location execution phase associated with the location preparation phase.

89. The non-transitory computer-readable medium of claim 87, wherein each of the plurality of durations corresponds to a different positioning frequency layer associated with the one or more positioning measurements.

90. The non-transitory computer-readable medium of claim 76, wherein at least the first start time for the one or more measurement periods comprises a sequence of a plurality of start times for the one or more measurement periods.

91. The non-transitory computer-readable medium of claim 90, wherein each of the plurality of start times corresponds to a different location execution phase associated with the location preparation phase.

92. The non-transitory computer-readable medium of claim 90, wherein each of the plurality of start times corresponds to a different positioning frequency layer associated with the one or more positioning measurements.

93. The non-transitory computer-readable medium of claim 76, wherein:
the request for measurement periods comprises a request for inter-frequency measurement gaps, and
the one or more measurement periods comprise one or more inter-frequency measurement gaps.

94. The non-transitory computer-readable medium of claim 93, wherein the one or more inter-frequency measurement gaps comprise one or more inter-frequency measurement gaps for positioning.

95. The non-transitory computer-readable medium of claim 76, wherein:
the request for measurement periods comprises a request for intra-frequency processing gaps, and
the one or more measurement periods comprise one or more intra-frequency processing gaps.

96. The non-transitory computer-readable medium of claim 76, wherein the location information request is a Long-Term Evolution (LTE) positioning protocol (LPP) Request Location Information message.

97. The non-transitory computer-readable medium of claim 76, wherein the request for measurement periods is signaled in one or more radio resource control (RRC) messages or one or more medium access control control elements (MAC-CEs).

98. The non-transitory computer-readable medium of claim 76, wherein:
the request for measurement periods comprises a “LocationMeasurementInfo” information element (IE), and
the requested offset is a nr-MeasPRS-RepetitionAndOffset parameter.

99. The non-transitory computer-readable medium of claim 76, wherein the one or more instructions further cause the UE to:
receive, from the serving base station, a response to the request for measurement periods, the response including at least a second start time for the one or more measurement periods, the second start time based on the first start time.

100. The non-transitory computer-readable medium of claim 99, wherein the second start time is the same as the first start time.
